(19) United States
(12) Patent Application Publication
(10) Pub. No.: US 2022/0251787 A1
(43) Pub. Date: Aug. 11, 2022

(54) PLAUSIBILITY CHECK OF A PAVING DATA SET FOR A ROAD CONSTRUCTION MACHINE

(71) Applicant: JOSEPH VOEGELE AG, Ludwigshafen/Rhein (DE)

(72) Inventor: Martin BUSCHMANN, Neustadt (DE)

(73) Assignee: JOSEPH VOEGELE AG, Ludwigshafen/Rhein (DE)

(21) Appl. No.: 17/592,903

(22) Filed: Feb. 4, 2022

(30) Foreign Application Priority Data
Feb. 5, 2021 (EP) 21155382.1

(51) Int. Cl. E01C 19/00; E01C 19/48

(52) U.S. Cl. CPC E01C 19/002; E01C 2301/10; E01C 19/4833

(57) ABSTRACT

A method for paving a road surface, wherein a paving data set is read into an on-board computer of a road construction machine. During a paving operation, working components of the road construction machine are controlled for paving the road surface on the, basis of the read-in paving data set. Before start of the paving operation, the paving data set is compared by a computing unit with a property profile of the road construction machine stored in a profile memory and, based on a result of the comparison, an assessment is made as to whether the road construction machine is suitable for paving the road surface.

### CROSS-REFERENCE TO RELATED APPLICATION

This application claims foreign priority benefits under 35 U.S.C. § 119(a)-(d) to European patent application number EP 21155382.1 filed Feb. 5, 2021, which is incorporated by reference in its entirety.

### TECHNICAL FIELD

This disclosure relates to the field of road construction by means of road construction machines, in particular by means of a road paver.

### BACKGROUND

In particular for complex construction sites, it may be advantageous to provide data relevant to the paving of a road surface in digital form. The digital data may, for example, define the road surface to be paved or settings for one or a plurality of road construction machines. With the aid of such digital data, the work, of the road construction machine operators may be simplified. The data may, for example, be created in advance in a planning process and then be read into an on-board computer of the road construction machine. Among other things, the data may be used for at least partial automation of the paving process. Accessing digital data created in a planning process during the paving operation may improve the planability and reproducibility of the paving operation.

In practice, it may occur that it is only discovered during the paving operation that a road construction machine, due to its configuration, is not capable of carrying out the planned paving operation in accordance with the specifications or actual conditions. This may result for example, the paving operation having to be interrupted and only be able to be continued after the road construction machine has been converted or another road construction machine has been made available. This may cause considerable delays in, the operating procedure. Forced interruption of a paving operation of a road paver may be particularly problematic, as it may result in irregularities in the paved road surface, for example, and thus have a negative impact on the quality of the road surface.

### SUMMARY

It is an, object of the disclosure to provide a method for paving a road surface with a road construction machine which is improved in terms of smooth operation and paving quality.

This object is solved by the subject matter of claim 1. The dependent claims indicate advantageous embodiments.

According to an embodiment, the disclosure relates to a method for paving a road surface. A paving data set is read into an on-board computer of a road construction machine. During a paving operation, working components of the road construction machine are controlled for paving the road surface based on the read-in paving dataset. The paving data set is compared with a property profile of the road construction machine by means of a computing unit before the paving operation is started. The property profile is stored in a profile memory. Also before the start of the paving operation, an assessment is made based on the result of the comparison as to whether the road construction machine is suitable for paving the road surface.

By comparing the paving data set with the property profile of the road construction machine, incompatibilities between the paving data set, on the basis of which the working components of the road construction machine are later controlled for paving the road surface, and the used road construction machine may be detected before the paving operation begins. If the comparison shows that the road construction machine is not suitable for paving the road surface, a corresponding reaction may be taken before the paving operation begins, for example by using a different road construction machine, by converting the road construction machine, and/or by adapting the paving data set. Interrupting a paving operation that has already started may thus be prevented in certain cases.

The road construction machine may be configured as a road construction vehicle and/or have its own traction drive.

According to an embodiment, the road construction machine is a road paver. However, the disclosure may also be applied to other road construction machines, such as a grader, a milling machine or a roller. The milling machine may be configured as a milling vehicle for removing an already paved road surface or a part thereof.

The paving operation includes the operation of the road construction machine to pave the road surface. If the road construction machine is a road paver, the paving operation may include laying the road surface. However, the laying of the road surface does not necessarily have to be carried out by the road construction machine itself. For example, the paving operation may include preparing the road base for, laying the road surface or finishing the laid road surface. If the road construction machine is configured as a milling machine, the paving operation may comprise a removal of a road surface previously provided on the road base with the milling machine. If the road construction machine is configured as a grader, the paving operation may include making or straightening the road base with the grader. If the road construction machine is configured as a roller, the paving operation may include compacting the laid road surface with the roller.

The paving data set may be provided in digital form. A digital paving data set may be created using planning software, for example. A digital paving data set may be transmitted easily and efficiently to the respective place of use, for example by wireless or wired data transmission or by means of a mobile data storage device, such as a memory card, a CD, a disk, a USB stick, a hard disk, or an SSD.

The property profile of the road construction machine may be provided as a data set in digital form. The property profile of the road construction machine may include information on properties and key figures of the road construction machine. The property profile of the road construction machine may include information on a machine specification of the road construction machine. The property profile of the road construction machine may include information defining which road surfaces may be paved with the road paver. The property profile of the road construction machine may specify upper and/or lower limit values for a setting of one or a plurality of operating parameters of the road construction machine.

The property profile of the road construction machine may specify, for example, one or a plurality of the following: a smallest possible (minimum) working width of the road construction machine, a largest possible (maximum) working width of the road construction machine, a maximum, adjustment speed of the working width of the road construction machine, a maximum paving speed of the road construction machine, a maximum conveying amount of paving material in the road construction machine per time unit, a maximum achievable compaction of the paving material by the road construction machine, a smallest possible (minimum) paving thickness when using the road construction machine, a largest possible (maximum) paving thickness when using the road construction machine.

The property profile of a road paver may relate to a road paver as a combination of tractor unit and paving screed. If the paving screed configuration of the road paver is changed or the paving screed is exchanged, a different property profile may be used.

The comparing of the paving data set with the property profile of the road construction machine by the computing unit may be performed according to rules. The rules may be deterministic rules. The rules may be predefined. The rules may be stored in a rule memory. The rules may be stored in digital form.

The comparing of the paving data set with the property profile of the road construction machine may include determining at least one comparison value from the paving data set. The rules may define how the at least one comparison value is determined from the paving data set. The at least one comparison value may correspond to a value included in the paving data set. The at least one comparison value may be calculated from one or a plurality of values of the paving data set. The at least one comparison value may be determined independently of the property profile of the road construction machine.

The at least one comparison value may be compared with the property profile of the road construction machine. The rules may define how the at least one comparison value is compared with the property profile of the road construction machine. The at least one comparison value may be compared to a property value included in the property profile of the road construction machine. The property value may be a limit value.

As an alternative to comparing the paving data set with the property profile of the road construction machine according to rules, the comparing of the paving data set with the property profile of the road construction machine may be performed by means of a simulation. The simulation may include simulating the road surface paving process with the road construction machine and according to the paving data set. The simulation may use the property profile of the road construction machine to describe the road construction machine.

As a result of the simulation, it may be determined whether the simulated paving operation was successful. For example, the simulated paving operation may be determined to be successful if no errors occurred during the simulated paving operation and/or the road surface or road base created in the simulation complies with the specifications. In particular, the specifications may result from the paving data set. If it is determined that the simulated paving operation was successful, it may be determined that the road construction machine is suitable for paving the road surface. Otherwise, it may be determined that the road construction machine is not suitable for paving the road surface.

The simulation may use a digital twin, which may alternatively be characterized as a digital version or a digital representation, of the road construction machine.

In the case of a road paver, the working components may include one or a plurality of the following: a traction drive of the road paver, a tamper of a paving screed of the road paver, a pressure bar of a paving screed of the road paver, a screed heater of the road paver, a mixed material transport device, an arrangement for adjusting the working width of the paving screed.

The working components of the road construction machine may be controlled automatically based on the paving data set read into the on-board computer of the road construction machine. The automatic control may be performed by the on-board computer or a control unit of the road construction machine. Automatic control of the working components of the road construction machine based on the read-in paving data set may result in the road surface being paved exactly according to the paving data set. Automatic control of the working components of the road construction machine may facilitate operation of the road construction machine during the paving process.

The working components of the road construction machine may be controlled manually based on the read-in paving data set. For example, based on the read-in paving data set, information may be displayed on a display device of the road construction machine. Based on the displayed information, an operator may control the working components of the road construction machine. Manually controlling the working components of the road construction machine allows the operator a certain degree of freedom. However, since the control is based on the paving data set read into the on-board computer of the road construction machine, it is still possible to ensure, at least to a certain extent, a paving result that corresponds to the planning.

It is conceivable that certain working components are controlled automatically and other working components are controlled manually.

It is conceivable that certain working components are controlled based on the read-in paving data set (automatically or manually) and other working components are controlled independently of the read-in paving data set (automatically or manually). Alternatively, all working components of the road construction machine may be controlled based on the read-in paving data set.

The paving data set may include a target data set that characterizes the road surface to be paved. Taking the target data set into account for comparison with the property profile of the road construction machine allows determining whether the road construction machine is suitable for paving the road surface in question. If the target data set is taken into account when controlling the working components of the road construction machine, the working components of the road construction machine may be controlled in accordance with the specifications of the road surface to be paved.

The target data set may be created based at least in part on at least one of the following: a measuring process, a construction process, map data (e.g., digital or non-digital maps), data from a navigation system (e.g., Google Maps), landscape images (e.g., aerial photos or construction site photos). The target data set may be created during a planning phase of the construction project. The target data set may be created before start of the paving process.

The target data set may define at least one of the following: a geometry of the road surface to be paved, at least one property of the paving material, at least one quality requirement of the road surface.

The geometry of the road surface to be paved may include, for example, one or a plurality of: a location of the road surface, a width of the road surface, a thickness of the road surface, a inclination of the road surface. The, at least one property of the paving material may include, for example, one or a plurality of: a type of the paving material, a composition of the paving material, a temperature of the paving material. The at least one quality requirement of the road surface material may comprise, for example, one or a plurality of: a minimum degree of compaction of the paving material in the road surface, a maximum unevenness of a surface of the road surface material.

The paving data set may include a parameter set with settings of operating parameters of the road construction machine. If the parameter set is taken into account when comparing the paving data set with the property profile of the road construction machine, it may be determined before paving begins whether the road construction machine is adapted for use with the settings from the parameter set.

In the case of a road paver, the parameter set may include a setting for one or a plurality of the following operating parameters: a paving speed of the paver, a stroke of a tamper of a paving screed of the road paver, a rotational speed of a tamper of a paving screed of the road paver, a vibration pressure, a vibration rotational speed, a pressure bar pressure, a pressure bar frequency, a temperature of a paving screed of the road paver, an angle of attack of a paving screed of the road paver, an extension width of a paving screed of the road paver, a mix temperature, a mixed material transport parameter.

The computing unit may be provided on the road construction machine. The computing unit may be part of the on-board computer of the road construction machine. The computing unit may be in communication with the on-board computer of the road construction machine. When the paving data set is read into the on-board computer of the road construction machine, the paving data set may be provided to the computing unit. If the computing unit is provided on the road construction machine, the paving data set may be compared with the property profile of the road construction machine, for example, directly before the start of the paving operation on the construction site, as a final plausibility check, so to speak.

The computing unit may be provided separately from the road construction machine. For example, the computing unit may be provided in a planning center or in a computer center. The computing unit may be configured as a server or be part of a server. The computing unit may be implemented on a mobile device, such as a notebook, a tablet, or a smartphone. If the computing unit is provided separately from the road construction machine, the comparison between the paving data set and the property profile of the road construction machine may be performed without access to the road construction machine. For example, the comparison may be performed as a preliminary check, especially in the office.

The profile memory may be provided on the road construction machine. The profile memory may be provided on the road construction machine if the computing unit is also provided on the road construction machine.

The profile memory may be provided separately from the road construction machine. The profile memory may be provided where the computing unit is also provided.

The method may include indicating a type of road construction machine. For example, a type of the road construction machine may be selected by means of an input device. When the disclosure is applied to a road paver, indicating a type of the road construction machine includes indicating a type of the road paver. For example, indicating the type of the road paver may include selecting a combination of a tractor vehicle and a paving screed. When the disclosure is, applied to a grader, indicating a type of the road construction machine includes indicating a type of the grader. When the disclosure is applied to a mill, indicating a type of the road construction machine includes indicating a type of the mill. When the disclosure is applied to a roller, indicating a type of the road construction machine includes indicating a type of the roller.

The property profile may be selected from a plurality of stored property profiles for different types of road construction machine based on the indication of the type of road construction machine. Thus, a suitable property profile may be selected based on an indication of the road construction machine provided for the paving operation. It is also possible to compare the paving data set with a plurality of property profiles corresponding to different types of road construction machine by means of the computing unit. This makes it possible to determine which road construction machine would be suitable for the paving job.

Alternatively, only a single property profile corresponding to a specific type of road construction machine may be stored in the profile memory.

In particular, it would be conceivable for the profile memory to include a plurality of property profiles relating to road paver types, that each have the same tractor unit but different paving screed configurations. If the computing unit and the profile memory are arranged on the road paver, it may be useful for the profile memory to contain only those property profiles that relate to the tractor unit of the road paver in question.

A result of the assessment of whether the road construction machine is suitable for paving the road surface may be output. In particular, the result of the assessment may be shown in a display unit.

### BRIEF DESCRIPTION OF THE DRAWINGS

In the following, the disclosure is further explained by means of embodiments.

FIG. 1 shows a schematic side view of a road construction machine configured as a road paver according to an embodiment;

FIG. 2 shows a schematic representation of a plausibility check method according to an embodiment; and

FIG. 3 shows a schematic representation of a plausibility unit according to an embodiment.

### DETAILED DESCRIPTION

As required, detailed embodiments of the present disclosure are described herein; however, it is to be understood that the disclosed embodiments are merely exemplary of the disclosure that may be embodied in various and alternative forms. The figures are, not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The embodiments described below relate to the application of the disclosure to a road paver. However, as described above, the disclosure may also be applied to other road construction machines, such as a grader, a mill or a roller.

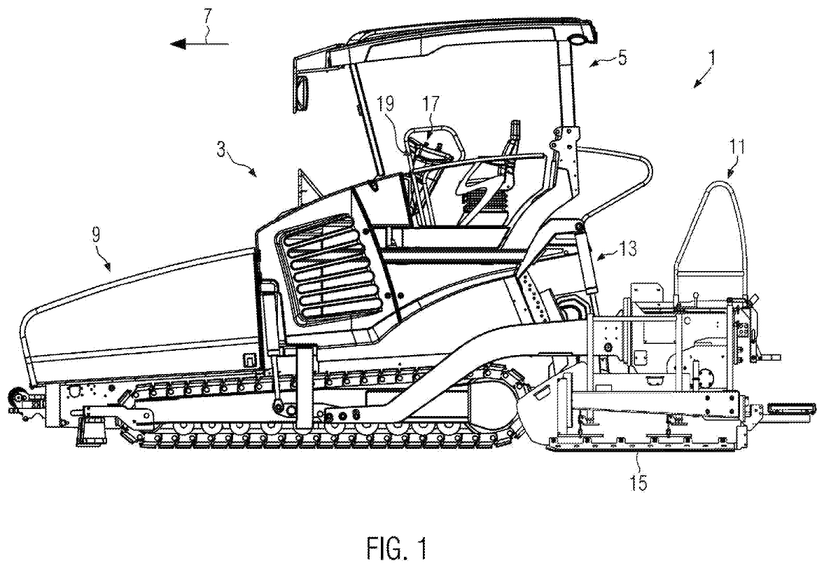

FIG. 1 shows a schematic representation of a road paver 1 for paving a road surface. The road paver 1 comprises a tractor unit 3 on which an operator's platform 5 is provided for an operator. The tractor unit 3 comprises a hopper 9 at the front in paving direction 7 for receiving material to be paved. The paving material is conveyed in front of a paving screed 11 of the road paver 1 against the direction of travel 7 by means of a conveyor. The paving screed 11 is attached to the tractor vehicle 3 and is towed behind the tractor vehicle 3. During a paving operation, the paving screed 11 lies floating on the paving material and compacts the paving material. An angle of attack of the paving screed 11 may be adjusted by means of an adjusting device 13. The paving screed 11 comprises a screed plate 15 and compacting units for compacting the paving material. The compacting units comprise, for example, a tamper and a pressure bar. The paving screed 11 comprises a heating device. The paving screed 11 may be a laterally extendable paving screed 11, with which the paving width may be adjusted. The paving screed 11 may comprise one or a plurality of screed members.

An operating console 17 is provided on the main operator control stand, which has operating elements with which an operator may control functions of the road paver 1. The operating console 17 may also have a display device, for example in the form of a screen. The road paver 1 comprises an on-board computer 19, which is integrated into the operating console 17 in the illustrated embodiment, but could also be provided elsewhere on the road paver 1.

Before starting the paving process, a target data set is created in a measuring or construction process. For example, map data, data from a navigation system and/or landscape images may be used. The target data set describes the road surface to be paved. In particular, the target data set describes a course and a geometry of the road surface to be paved. The target data set may, for example, specify the paving material to be used and one or a plurality of quality requirements for the road surface, such as minimum compaction.

Also before starting the paving process, a parameter set with settings of operating parameters of the road paver 1 is created. The parameter set may be created with regard to the target data set or based on the target data set. The parameter set may include settings of operating parameters of the road paver 1. For example, the parameter set may include settings for the following operating parameters of the road paver 1: a paving speed of the road paver 1, a stroke of a tamper of the paving screed 11, a rotational speed of a tamper of the paving screed 11, a vibration pressure, a vibration rotational speed, a pressure bar pressure, a pressure bar frequency, a temperature of the paving screed 11, an angle of attack of the paving screed 11, an extension width of the paving screed 11, a mixed material temperature, a mixed material transport parameter.

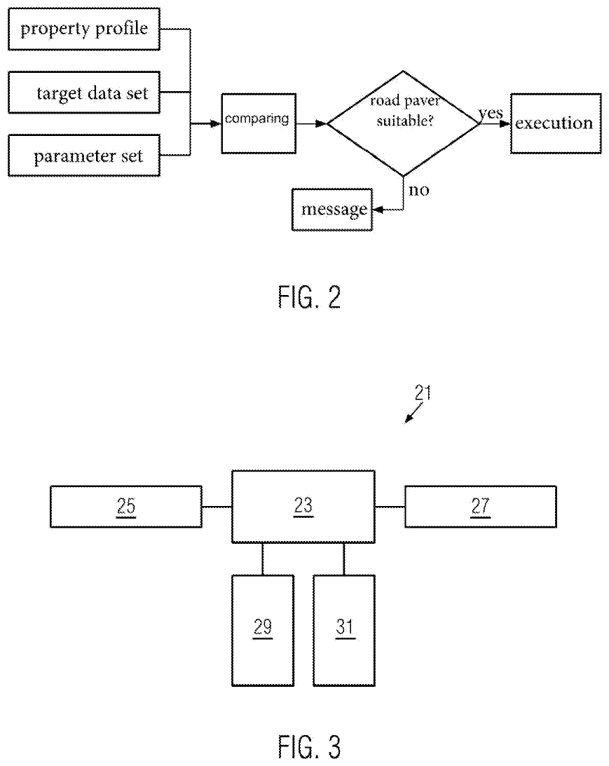

In addition to creating the target data set and the parameter set, the road paver 1 to be used for the paving operation is determined in a planning process. Before starting the paving operation, a plausibility check is carried out to determine whether the road paver 1 is suitable for paving the road surface. FIG. 2 schematically shows a corresponding plausibility check method. Based on the indication or selection of the road paver 1, a stored property profile of the road paver 1 is accessed. The property profile of the road paver 1 describes properties of the road paver 1 relevant for the application, such as: a smallest possible (minimum) working width of the road paver 1, a largest possible (maximum) working width of the road paver 1, a maximum adjustment speed of the working width of the road paver 1, a maximum paving speed of the road paver 1, a maximum conveying quantity of paving material in the road paver 1 per unit of time, a maximum achievable compaction of the paving material by the road paver 1, a smallest possible (minimum) paving thickness when using the road paver 1, a largest possible (maximum) paving thickness when using the road paver 1.

The target data set and the parameter set are compared with the property profile. Based on the result of the comparison, an assessment is made as to whether the road paver 1 is suitable for carrying out the paving operation for paving the road surface in accordance with the target data set and using the parameter set. If this assessment shows that the road paver 1 is not suitable, a corresponding message is issued. The planning of the paving operation may then be revised in good time before the start of paving. For example, the properties of the road surface to be paved, the parameter set or the selection of road paver 1 may be revised.

If the assessment shows that the road paver 1 is suitable for the paving process, the paving process may be started. If not already done, the target data set and the parameter set are read into the on-board computer 19 of the road paver 1. During the paving process, the working components of the road paver 1 are then controlled based on the read-in data (target data set and parameter set). This may be done automatically, for example by the on-board computer 19 of the road paver 1, or manually by an operator. For example, instructions could be displayed to the operator on the screen of the operator console 17 based on the target data set and the parameter set, and the operator could control the working components of the road paver 1 based on these instructions.

In the described embodiment, both the target data set and the parameter set are compared with the property profile. However, this is not absolutely necessary. It is also possible to compare only the target data set with the property profile, or to compare only the parameter set with the property profile. Likewise, according to the described embodiment, both the target data set and the parameter set are read into the on-board computer 19 of the road paver 1 and used as a basis for controlling the working components of the road paver 1. Alternatively, however, only the target data set or only the parameter set could be read into the on-board computer 19 of the road paver 1 and used as the basis for the paving process.

FIG. 3 shows a schematic representation of an embodiment of a plausibility check unit 21, which compares the target data set and/or the parameter set (paving data set) with the property profile of the road paver 1. The plausibility check unit 21 may also perform the assessment of whether the road paver 1 is suitable for paving the road surface. The plausibility check unit 21 comprises a computing unit 23 with a data input 25 and a data output 27. Furthermore, the plausibility check unit 21 comprises a profile memory 29 and a memory 31.

The plausibility check unit 21 may be provided on the road paver 1. For example, the plausibility check unit 21 may be part of the on-board computer 19 of the road paver 1 or be in communication with the on-board computer 19 of the road paver 1. Alternatively, the plausibility check unit 21 may be provided completely or partially separately from the road paver 1, for example in a planning center or in a mobile unit.

The target data set and the parameter set are made available to the plausibility check unit 21 via the data input 25. In case the plausibility check unit 21 is provided on the road paver 1, the target data set and the parameter set only have to be read in once and may then be made available to both the on-board computer 19 and the plausibility check unit 21.

At least one property profile for a road paver 1 is stored in the profile memory 29. If a plurality of different property profiles are stored in the profile memory 29, a selection of a road paver type may be received via the data input 25. Based on the selection of the road paver type, a property profile from the profile memory 29 associated with the corresponding road paver type may be used. If only a single property profile is stored in the profile memory 29, no selection of a road paver type is required. In this case, the system would be fixed to one road paver type. This is particularly convenient if the plausibility check unit 21 is provided on the road paver 1 of the corresponding type.

According to an embodiment, the memory 31 is adapted as a rule memory. The computing unit 23 accesses the rule memory 31, which stores rules according to which the computing unit 23 performs the comparison of the target data set and/or the parameter set with the property profile. During the comparison, one or a plurality of comparison values may be determined from the target data set and/or the parameter set, which are compared with one or more property values from the property profile of the road paver 1. The assessment based on the result of the comparison as to whether the road paver 1 is suitable for paving the road surface is also carried out in accordance with rules stored in the rules memory 31. The result of the assessment is output via data output 27 and may be displayed on a screen, for example. If the plausibility check unit 21 is provided on the road paver 1, the result of the assessment may be output on a screen of the operator console 17, for example.

According to an alternative embodiment, the memory 31 is adapted as a memory 31 that stores program instructions for performing a simulation. In this embodiment, the matching of the paving data set with the property profile of the road paver 1 is performed by means of a simulation of the paving process of the road surface with the road paver 1 and according to the paving data set. The simulation may use a digital twin, which may alternatively be characterized as a digital version or a digital representation, of the road paver 1 and accesses the property profile of the road paver 1 to describe the road paver 1. Based on the simulation, it is determined whether the simulated paving operation was successful. The simulated paving operation is determined successful if no faults occurred during the simulated paving operation and/or the road surface paved in the simulation complies with the specifications. In particular, the specifications may be obtained from the paving data set. If it is determined that the simulated paving operation was successful, it is determined that the road paver is suitable for paving the road surface. Otherwise, it is determined that the road paver is not suitable for paving the road surface. The result of the evaluation of whether the road paver 1 is suitable for paving the road surface is output via the data output 27 and may be displayed on a screen, for example. If the plausibility check unit 21 is provided on the road paver 1, the result of the assessment may be output, for example, on a screen of the operating console 17.

It is noted that the on-board computer 19, plausibility check unit 21, and computing unit 23 with data input 25, data output 27, profile memory 29, and/or memory 31, and any other unit, control unit, controller, console, algorithm, device, feature, system, functionality, module, arrangement, or the like described herein may comprise and/or be implemented in or by one or more appropriately programmed processors (e.g., one or more microprocessors including central processing units (CPU)) and associated memory and/or storage, which may include data, firmware, operating system software, application software and/or any other suitable program, code or instructions executable by the processor(s) for controlling operation thereof and/or for performing the particular algorithms represented by the various functions and/or operations described herein, including interaction between and/or cooperation with each other. One or more of such processors, as well as other circuitry and/or hardware, may be included in a single ASIC (Application-Specific Integrated Circuitry) or individually packaged or assembled into a SoC (System-on-a-Chip). As well, several processors and various circuitry and/or hardware may be distributed among several separate components and/or locations, such as a road construction machine, a mobile unit or mobile computing device, or a remote server.

While exemplary embodiments are described above, it is not intended that these embodiments describe all possible forms of the disclosure. Rather, the words used in the specification are words of description rather than limitation, and it is understood that various changes may be made without departing from the spirit and scope of the following claims. Additionally, the features of various implementing embodiments may be combined to form further embodiments of the disclosure.

What is claimed is:

1. A method for paving a road surface, comprising:
reading-in a paving data set into an on-board computer of a road construction machine comprising a road paver; and
during a paving operation: controlling working components of the road construction machine for paving the road surface based on the read-in paving data set,
wherein, before start of the paving operation, the paving data set is compared by a computing unit with a property profile of the road construction machine stored in a profile memory and, based on a result of the comparison, an assessment is made that the road construction machine is suitable for paving the road surface.

2. The method according to claim 1, wherein the comparing of the paving data set with the property profile of the road construction machine is performed by the computing unit according to rules which are stored in a rule memory.

3. The method according to claim 1, wherein the comparing of the paving data set with the property profile of the road construction machine comprises determining at least one comparison value from the paving data set, wherein the at least one comparison value is compared with the property profile of the road construction machine.

4. The method according to claim 1, wherein the comparing of the paving data set with the property profile of the road construction machine is performed by a simulation, which comprises simulating a paving process of the road surface with the road construction machine and according to the paving data set.

5. The method according to claim 4, wherein the simulation uses a digital twin of the road construction machine.

6. The method according to claim 1, wherein the working components of the road construction machine are automatically controlled based on the read-in paving data set.

7. The method according to claim 1, wherein the paving data set comprises a target data set characterizing the road surface to be paved.

8. The method according to claim 7, wherein the target data set is created based at least in part on at least one of: a measuring process, a construction process, map data, data from a navigation system, landscape images.

9. The method according to claim 7, wherein the target data set defines at least one of the following: a geometry of the road surface to be paved, at least one property of the paving material, at least one quality requirement.

10. The method according to claim 1, wherein the paving data set comprises a parameter set with settings of operating parameters of the road construction machine.

11. The method of claim 10, wherein the parameter set comprises a setting for one or a plurality of the following operating parameters: a paving speed of the road paver, a stroke of a tamper of a paving screed of the road paver, a rotational speed of a tamper of a paving screed of the road paver, a vibration pressure, a vibration rotational speed, a pressing bar pressure, a pressing bar frequency, a temperature of a paving screed of the road paver, an angle of attack of a paving screed of the road paver, an extension width of a paving screed of the road paver, a mixed material temperature, a mixed material transport parameter.

12. The method according to claim 1, wherein the computing unit and/or the profile memory is provided on the road construction machine.

13. The method according to claim 1, wherein the computing unit and/or the profile memory is provided separately from the road construction machine.

14. The method according to claim 1, wherein a type of the road construction machine is indicated and the property profile is selected from a plurality of stored property profiles for different types based on the indication of the type of road construction machine.

15. The method according to claim 1, wherein a result of the assessment of whether the road construction machine is suitable for paving the road surface is output.

16. A method for paving a road surface, comprising:
comparing, by a computing unit before start of a paving operation by a road construction machine, a paving data set with a property profile of the road construction machine stored in a profile memory;
assessing, by the computing unit before start of a paving operation by the road construction machine, whether the road construction machine is suitable for paving the road surface based on a result of the comparing of the paving data set with the stored property profile; and
controlling working components of the road construction machine during a paving operation based on the paving data set, when the road construction machine has been assessed suitable for paving the road surface.

17. The method according to claim 16, wherein the comparing of the paving data set with the stored property profile of the road construction machine comprises performing, via execution of stored program instructions by the computing unit, a simulation of a paving process of the road surface with the road construction machine according to the paving data set.

18. The method according to claim 17, wherein the simulation uses a digital representation of the road construction machine.

19. A non-transitory computer readable medium having stored program instructions for use in paving a road surface, the program instructions being executable by at least one processor to:
compare, before start of a paving operation by the road construction machine, a paving data set with a property profile of a road construction machine;
assess, before start of a paving operation by the road construction machine, whether the road construction machine is suitable for paving a road surface based on a result of the comparison of the paving data set with the property profile; and
control working components of the road construction machine during a paving operation based on the paving data set, when the road construction machine has been assessed suitable for paving the road surface.

20. The non-transitory computer readable medium according to claim 19, wherein, to compare the paving data set with the property profile of the road construction machine, the program instructions are executable by the at least one processor to perform a simulation of the paving process of the road surface with the road construction machine according to the paving data set.
